(19) United States
(12) Patent Application Publication
(10) Pub. No.: US 2023/0122779 A1
(43) Pub. Date: Apr. 20, 2023

(54) STRENGTH-TYPE INTELLIGENT FITNESS EQUIPMENT AND CALIBRATION METHODS FOR OUTPUT FORCE OF THE STRENGTH-TYPE INTELLIGENT FITNESS EQUIPMENT

(71) Applicant: CHENGDU FIT-FUTURE TECHNOLOGY CO., LTD., Chengdu (CN)

(72) Inventors: Bowen ZHANG, Chengdu (CN); Weitao XI, Chengdu (CN); Jiabin SHI, Chengdu (CN); Qiang FU, Chengdu (CN); Yuhan TANG, Chengdu (CN)

(73) Assignee: CHENGDU FIT-FUTURE TECHNOLOGY CO., LTD., Chengdu (CN)

(21) Appl. No.: 18/045,498

(22) Filed: Oct. 11, 2022

(30) Foreign Application Priority Data
Oct. 14, 2021 (CN) 202111198938.5

(51) Int. Cl. A63B 21/00

(52) U.S. Cl. CPC A63B 21/00069; A63B 21/154; A63B 2220/51; A63B 2225/02; A63B 2220/58; A63B 2220/17; A63B 2220/80

(57) ABSTRACT

The present disclosure discloses a calibration method for output force of strength-type intelligent fitness equipment, which belongs to the field of intelligent fitness, including: connecting a tension detection device to the strength-type intelligent fitness equipment; obtaining an actual tension of the strength-type intelligent fitness equipment by turning on the tension detection device to perform detection; obtaining a tension deviation based on a target tension of the strength-type intelligent fitness equipment and the actual tension; and calibrating the strength-type intelligent fitness equipment based on the tension deviation.

### CROSS-REFERENCE TO RELATED DISCLOSURES

This application claims priority to Chinese Patent Application No. 202111198938.5, filed on Oct. 14, 2021, the entire contents of which are hereby incorporated by reference.

### TECHNICAL FIELD

The present disclosure relates to the field of intelligent fitness, in particular to calibration methods for output force of the strength-type intelligent fitness equipment.

### BACKGROUND

The working principle of strength-type intelligent fitness equipment is that: strength-type intelligent fitness equipment includes a motor, a differential, support arms, a pull rope and corresponding controllers, circuit, and accessories. A belt is connected between an output shaft of the motor and the differential, one end of the pull rope is connected to the differential, and the other end of the pull rope is connected to a corresponding pull ring or other fitness accessories after moving along the support arms. When exercising, a user may exercise by pulling the pull rope, or use the support arms to exercise. The pull rope drives the motor to move through the differential and the belt. When the motor is energized, an output torque (i.e., the resistance) is generated, and the user needs to overcome the output torque of the motor when pulling the pull rope, thus realizing the purpose of strength training for the user.

The strength-type intelligent fitness equipment provides a load to the user through the output force to achieve the purpose of impedance training. There is a deviation between the set force and the actual output force, and the existing technology may not accurately obtain the above deviation.

### SUMMARY

In order to realize the accurate output force of the strength-type intelligent fitness equipment, the present disclosure provides the calibration method for output force of the strength-type intelligent fitness equipment. By calibrating the output force of the strength-type intelligent fitness equipment, the output force may be accurately outputted.

In order to realize the above purpose, the present disclosure provides the calibration method for output force of the strength-type intelligent fitness equipment, including: connecting a tension detection device to the strength-type intelligent fitness equipment; obtaining an actual tension of the strength-type intelligent fitness equipment by turning on the tension detection device to perform detection; obtaining a tension deviation based on a target tension of the strength-type intelligent fitness equipment and the actual tension; and calibrating the strength-type intelligent fitness equipment based on the tension deviation.

The principle of the method is: connecting the tension detection device to the strength-type intelligent fitness equipment, detecting an output force of the strength-type intelligent fitness equipment through the strength-type intelligent fitness equipment, and obtaining the tension deviation based on the target tension and the actual tension of the strength-type intelligent fitness equipment; and using the obtained tension deviation to calibrate the strength-type intelligent fitness equipment, so that the output force of the calibrated strength-type intelligent fitness equipment is accurate.

Preferably, the tension detection device is a tension table, which connects a tension sensor of the tension detection device to a pull rope of the strength-type intelligent fitness equipment. The corresponding tension may be generated by using the tension table to pull the pull rope of the strength-type intelligent fitness equipment, and the tension may be measured by the tension sensor.

Preferably, the pull rope is connected to the tension sensor after bypassing a fixed pulley. The direction of the acting force may be changed through the fixed pulley, which is convenient for calibration in practice.

Preferably, the detection process of the tension detection device is that the tension sensor carries the pull rope to perform a round-trip movement at a constant speed. The constant-speed movement avoids the influence of motor inertia on the output force, which making the output force stable. The constant-speed movement facilitates the stability of the output force of the strength-type intelligent fitness equipment, which facilitates the accuracy of a final calibration result.

Preferably, the tension sensor carries the pull rope to perform N groups of round-trip movements, and each group includes at least 2 round-trip movements. The tension of the tension table in each group of round-trip movement is constant. The purpose of performing a plurality of groups of round-trip movements is to obtain more data, reduce the risk of incorrect data, and ensure the accuracy of calibration. The purpose of performing round-trip movement is that the output force in different directions is different. In order to achieve accurate calibration, it is necessary to perform the round-trip movement, and the corresponding output force is respectively calibrated by the round-trip movement. In each group of round-trip movement, the tension of the tension table is constant to obtain stable output force data.

Preferably, the tension of the tension table corresponding to any two groups of the round-trip movements is different. Different sizes of tension are used for testing to cover the range of output tensile force from small to large, and establish accurate tension and friction models. The purpose of this design is to obtain the output force data of different sizes, and finally calculate the accurate output force of the strength-type intelligent fitness equipment through these data to ensure the final accuracy.

Preferably, the corresponding tension of the tension table from the first group of round-trip movement to the Nth group of round-trip movement progressively increases, which facilitates the testing process and is reasonable.

Preferably, the method further includes: sampling the tension of the tension detection device at a preset frequency.

Preferably, the unilateral distance of the round-trip movement is S, and the actual tension of the strength-type intelligent fitness equipment is calculated by taking the tension data of a stroke of 1/4 S to 3/4 S. The purpose of this design is to avoid the sudden change of tension data caused by factors such as connecting sensors at the beginning or end of the stroke.

Preferably, the actual tension of the strength-type intelligent fitness equipment is Fₒᵤₜ when the pull rope is pulled out, the actual tension of the strength-type intelligent fitness equipment is Fᵢₙ when the pull rope is pulled in, and the output force of the strength-type intelligent fitness equipment is Fₘₒₜₒᵣ, and Fₘₒₜₒᵣ=(Fₒᵤₜ+Fᵢₙ)/2.

One or more technical schemes provided by the present disclosure have at least the following technical effects or advantages: this method may calibrate the output force of the strength-type intelligent fitness equipment, and the calibration result is accurate.

### BRIEF DESCRIPTION OF THE DRAWINGS

The accompanying drawings described herein are used to provide further understanding of the embodiments of the present disclosure, and constitute a part of the present disclosure, but do not constitute a limitation to the embodiments of the present disclosure, wherein:

FIG. 1 is a schematic diagram of the principle of the calibration method for output force of the strength-type intelligent fitness equipment.

### DETAILED DESCRIPTION

In order to be able to understand the above objects, features, and advantages of the present disclosure more clearly, the present disclosure may be further described in detail below with reference to the accompanying drawings and specific embodiments. It should be noted that the embodiments of the present disclosure and the features in the embodiments may be combined with each other under the condition that they do not conflict with each other.

Many specific details are set forth in the following description to facilitate a full understanding of the present disclosure. However, the present disclosure may also be implemented in other ways that are different from the scope of this description. Therefore, the protection scope of the present disclosure is not subject to the limitations of the specific embodiments of the following disclosure.

### Example 1

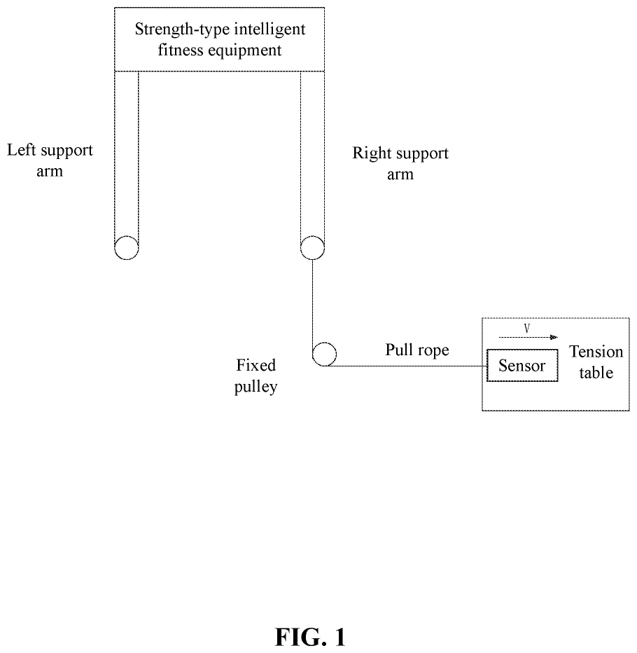

Please refer to FIG. 1, FIG. 1 is a schematic diagram of the principle of the calibration method for output force of the strength-type intelligent fitness equipment. An embodiment of the present disclosure provides the calibration method for output force of the strength-type intelligent fitness equipment, including: connecting tension detection device to the strength-type intelligent fitness equipment; obtaining an actual tension of the strength-type intelligent fitness equipment by turning on the tension detection device to perform detection; obtaining a tension deviation based on a target tension and the actual tension of the strength-type intelligent fitness equipment; and calibrating the strength-type intelligent fitness equipment based on the tension deviation.

The tension detection device in this embodiment is a tension table, a tension device, or a tension detector. In practical applications, the tension detection device may also be other types of tension detection device. The embodiment of the present disclosure does not limit the specific implementation of the tension detection device.

In the embodiments of the present disclosure, the purpose of calibrating the output force of the strength-type intelligent fitness equipment is that: the strength-type intelligent fitness equipment provides a load to a user through the output force to achieve the purpose of impedance training. There is a deviation between the set force and the actual output force, and the deviation needs to meet a certain standard. Therefore, it is necessary to perform calibration for output force and calibration compensation for output force of each set of equipment before leaving the factory, so that the deviation meets the corresponding standard. The calibration process is the process of obtaining an actual output force data and establishing an output force model. The process of correcting the output force through the output force model is called as a compensation process.

The deviation types of output force of strength-type intelligent fitness equipment are divided into two categories.

The deviation of the output force is related to the size of the target force and a pull-out stroke, and the deviation is also different for different machines and different support arms of the same machine. The deviation is considered to be independent of speed, and the deviation consists of as follows.

The first category is a deviation caused by the structure.

a. The difference in the actual average tension of left and right support arms.

b. The difference between actual tension strokes of a single support arm (difference between the maximum instantaneous force and the minimum instantaneous force in the process of pulling out or pulling in at a constant speed).

The second category is a calibratable deviation.

c. The deviation between the actual average tension of the single support arm and the target tension.

The strength-type intelligent fitness equipment needs to meet the same tension accuracy requirements during the pull-out stage and the pull-in stage: −(0.5+5% F)<delta<(0.5+5% F), where F is the size of the set force, delta is the above-mentioned c deviation, and the deviation standards of a and b are different from that of c.

The tension detection device is connected to the strength-type intelligent fitness equipment, the output force of the strength-type intelligent fitness equipment is detected through the strength-type intelligent fitness equipment, and the tension deviation is obtained based on the target tension and the actual tension of the strength-type intelligent fitness equipment; the strength-type intelligent fitness equipment is calibrated by using the obtained tension deviation, and the calibrated output force of the strength-type intelligent fitness equipment is accurate.

In the embodiments of the present disclosure, the tension detection device is the tension table, the tension sensor of which is connected to the pull rope of the strength-type intelligent fitness equipment. Corresponding tension may be generated by using the tension table to pull the pull rope of the strength-type intelligent fitness equipment and the tension may be measured through the tension sensor.

In the embodiment of the present disclosure, the pull rope is connected to the tension sensor after bypassing the fixed pulley. The direction of the acting force may be changed through the fixed pulley, which is convenient for calibration in practice.

In the embodiment of the present disclosure, the detection process of the tension detection device is that the tension sensor carries the pull rope to perform a round-trip movement at a constant speed. The constant-speed movement facilitates the stability of the output force of the strength-type intelligent fitness equipment, which facilitates the accuracy of the final calibration result.

In the embodiment of the present disclosure, the tension sensor carries the pull rope to perform N groups round-trip movements, and each group includes 2 round-trip movements; the tension of the tension table in each group of round-trip movement is constant. The purpose of performing a plurality of groups of round-trip movements is to obtain more data, reduce the risk of incorrect data, and ensure the accuracy of calibration. The purpose of performing round-trip movements is that the output force in different directions is different. In order to achieve accurate calibration, it is necessary to perform round-trip movements. The corresponding output force is respectively calibrated through round-trip movements. The tension of the tension table in each group of round-trip movement is constant to obtain stable output force data.

In the embodiments of the present disclosure, the tension of the tension table corresponding to any two groups of round-trip movements is different. The purpose of this design is to obtain the output force data of different sizes, and finally calculate the accurate output force of the strength-type intelligent fitness equipment through these data to ensure the final accuracy.

In the embodiments of the present disclosure, the corresponding tension of the tension table from the first group of round-trip movement to the Nth group of round-trip movement progressively increases.

In the embodiments of the present disclosure, the method further includes: sampling the tension of the tension detection device at a preset frequency.

In the embodiments of the present disclosure, the unilateral distance of the round-trip movement is S, and the actual tension of the strength-type intelligent fitness equipment is calculated by taking the tension data of a stroke of 1/4S to 3/4S.

Specific calibration method is as follows.

The tension table is used for tension calibration. When calibrating, the tension sensor of the tension table is connected to the pull rope. The tension table may control the tension sensor to move at a constant speed of 0.2 m/s, and save the data of the tension sensor in real time at 50 Hz to detect the actual tension of the pull rope at this time and compare it with the actual tension of the strength-type intelligent fitness equipment to calibrate the tension.

As shown in FIG. 1, the fixed pulley may be used, or the pull rope may be directly connected to the tension sensor.

The calibration steps in the embodiment of the present disclosure are as follows.

From the minimum force to the maximum force, evenly taking four points, such as 3 kg, 10 kg, 30 kg, 50 kg, or taking one point every 20 kg, and setting the set force to the above tension in turn.

1. For setting each tension, controlling the sensor on the tension table to perform round-trip movement twice at a constant speed of 0.2 m/s, with a single stroke of 800 mm, and sampling the tension at a frequency of 50 Hz. The interval between each round-trip movement is 1.5 s, and the speed change interval is 0.5 s.

2. Taking a tension data with a stroke of 200˜600 mm.

3. Calculating a difference between the average tension, the maximum tension, and the minimum tension.

4. Repeating steps 2 and 3 on the other support arm.

The calibration principle in this embodiment is as follows.

Assuming that the actual output tension of the strength-type intelligent fitness equipment is linearly related to the set tension, setting the actual output tension of the motor as Fₘₒₜₒᵣ, the set tension as F_{config}, and the absolute value of friction force is f, letting:

Fₘₒₜₒᵣ=k₁F_{config}+b₁.

f=k₂F_{config}+b₂.

Assuming that in the pull-out stage, the actual tension is Fₒᵤₜ, and in the pull-in stage, the actual tension is Fᵢₙ, including:

Fₒᵤₜ=Fₘₒₜₒᵣ+f.

Fᵢₙ=Fₘₒₜₒᵣ−f.

That is, in the pull-out stage:

F_{config}=(Fₒᵤₜ−(b₁+b₂))/(k₁+k₂).

In the pull-in stage:

F_{config}=(Fᵢₙ−(b₁−b₂))/(k₁−k₂).

When carrying out the tension calibration, the expected configuration tension is calculated according to the actual average tension in the pull-out and pull-in stages, and the original expected tension is replaced to achieve the effect of tension calibration, where k₁, k₂, b₁ and b₂ are all corresponding coefficients.

Assuming that the absolute value of the friction force in the pull-out and pull-in stages is equal when the tension calibration is not performed, the friction force may be determined according to the difference between the pull-out and pull-in forces: f=(Fₒᵤₜ−Fᵢₙ)/2.

Therefore, the output tension of the motor may be obtained as: Fₘₒₜₒᵣ=(Fₒᵤₜ+Fᵢₙ)/2.

The tension table is used for calibration, the tension table is controlled to pulled out and pulled in at a constant speed, the tension of the pull rope may be monitored in real time through the tension sensor of the tension table, and the tension deviation may be obtained by comparing the actual tension and the target tension to perform tension calibration.

Although preferred embodiments of the present disclosure have been described, additional changes and modifications to these embodiments may occur to technicians skilled in the art once the basic inventive concepts are known. Therefore, the appended claims are intended to be construed to include the preferred embodiment and all changes and modifications that fall within the scope of the present disclosure.

It will be apparent to technicians skilled in the art that various modifications and variations may be made in the present disclosure without departing from the spirit and scope of the disclosure. Thus, provided that these modifications and variations of the present disclosure fall within the scope of the claims of the present disclosure and their equivalents, the present disclosure is also intended to include these modifications and variations.

What is claimed is:

1. A calibration method for output force of strength-type intelligent fitness equipment, comprising:
connecting a tension detection device to the strength-type intelligent fitness equipment;
obtaining an actual tension of the strength-type intelligent fitness equipment by turning on the tension detection device to perform detection;
obtaining a tension deviation based on a target tension of the strength-type intelligent fitness equipment and the actual tension; and
calibrating the strength-type intelligent fitness equipment based on the tension deviation.

2. The calibration method of claim 1, wherein the tension detection device is a tension table, and a tension sensor of the tension detection device is connected to a pull rope of the strength-type intelligent fitness equipment.

3. The calibration method of claim 2, wherein the pull rope is connected to the tension sensor after bypassing a fixed pulley.

4. The calibration method of claim 2, wherein a detection process of the tension detection device is that the tension sensor carries the pull rope to perform a round-trip movement at a constant speed.

5. The calibration method of claim 4, wherein the tension sensor carries the pull rope to perform N groups of round-trip movements, N denotes an integer greater than 1, each group of the round-trip movement includes 2 round-trip movements, and a tension of the tension table in each group of round-trip movement is constant.

6. The calibration method of claim 5, wherein the tension of the tension table corresponding to any two groups of the round-trip movements is different.

7. The calibration method of claim 5, wherein the tension of the tension table from the first group of round-trip movement to the Nth group of round-trip movement progressively increases.

8. The calibration method of claim 1, further comprising: sampling tension of the tension detection device at a preset frequency.

9. The calibration method of claim 4, wherein a unilateral distance of the round-trip movement is S, and the actual tension of the strength-type intelligent fitness equipment is calculated by taking tension data of a stroke of 1/4 S to 3/4 S.

10. The calibration method of claim 4, wherein the actual tension of the strength-type intelligent fitness equipment is Fₒᵤₜ when the pull rope is pulled out, the actual tension of the strength-type intelligent fitness equipment is Fᵢₙ when the pull rope is pulled in, and the output force of the strength-type intelligent fitness equipment is Fₘₒₜₒᵣ, wherein Fₘₒₜₒᵣ (Fₒᵤₜ+Fᵢₙ)/2.

11. Strength-type intelligent fitness equipment, comprising:
at least one processor;
and one or more memories coupled to the at least one processor and storing programming instructions for execution by the at least one processor to:
connect a tension detection device to the strength-type intelligent fitness equipment;
obtain an actual tension of the strength-type intelligent fitness equipment by turning on the tension detection device to perform detection;
obtain a tension deviation based on a target tension of the strength-type intelligent fitness equipment and the actual tension; and
calibrate the strength-type intelligent fitness equipment based on the tension deviation.

12. The strength-type intelligent fitness equipment of claim 11, wherein the tension detection device is a tension table, and a tension sensor of the tension detection device is connected to a pull rope of the strength-type intelligent fitness equipment.

13. The strength-type intelligent fitness equipment of claim 12, wherein the pull rope is connected to the tension sensor after bypassing a fixed pulley.

14. The strength-type intelligent fitness equipment of claim 12, wherein a detection process of the tension detection device is that the tension sensor carries the pull rope to perform a round-trip movement at a constant speed.

15. The strength-type intelligent fitness equipment of claim 14, wherein the tension sensor carries the pull rope to perform N groups of round-trip movements, N denotes an integer greater than 1, each group of the round-trip movement includes 2 round-trip movements, and a tension of the tension table in each group of round-trip movement is constant.

16. The strength-type intelligent fitness equipment of claim 15, wherein the tension of the tension table corresponding to any two groups of the round-trip movements is different.

17. The strength-type intelligent fitness equipment of claim 15, wherein the tension of the tension table from the first group of round-trip movement to the Nth group of round-trip movement progressively increases.

18. The strength-type intelligent fitness equipment of claim 11, the programming instructions are for execution by the at least one processor to:
sample tension of the tension detection device at a preset frequency.

19. The strength-type intelligent fitness equipment of claim 14, wherein a unilateral distance of the round-trip movement is S, and the actual tension of the strength-type intelligent fitness equipment is calculated by taking tension data of a stroke of 1/4 S to 3/4 S.

20. The strength-type intelligent fitness equipment of claim 14, wherein the actual tension of the strength-type intelligent fitness equipment is Fₒᵤₜ when the pull rope is pulled out, the actual tension of the strength-type intelligent fitness equipment is Fᵢₙ when the pull rope is pulled in, and the output force of the strength-type intelligent fitness equipment is Fₘₒₜₒᵣ, wherein Fₘₒₜₒᵣ (Fₒᵤₜ+Fᵢₙ)/2.
